(19) United States
(12) Patent Application Publication
(10) Pub. No.: US 2010/0235202 A1
(43) Pub. Date: Sep. 16, 2010

(54) IMPROVEMENTS RELATING TO MANAGEMENT SYSTEMS

(75) Inventors: Grant Strelling, St. Albans (GB); Phil Brown, Staines (GB)

Correspondence Address: DINSMORE & SHOHL LLP, FIFTH THIRD CENTER, ONE SOUTH MAIN STREET, SUITE 1300, DAYTON, OH, 45402-2023, US

(73) Assignee: PROACTIVE ONLINE SOLUTIONS LIMITED, Bedford (GB)

(21) Appl. No.: 12/160,340

(22) PCT Filed: Jan. 10, 2007
(86) PCT No.: PCT/GB07/00057

§ 371 Date: Nov. 6, 2008

(30) Foreign Application Priority Data
Jan. 10, 2006 (GB) 0600421.2

(51) Int. Cl. G06Q 10/00; G06F 3/048; G06F 17/30; G06F 21/00; G06F 15/16

(52) U.S. Cl. 705/7; 705/348; 705/342; 705/301; 715/810; 707/706; 726/4; 709/219; 715/764; 707/E17.014

(57) ABSTRACT

The present invention relates to a management system for assisting a user in the management of a complex workflow process, the system being arranged to generate and record data regarding a sequence of events occurring over time constituting the complex workflow process. The system comprises a communications server which is arranged to output to a remote user terminal, and which is also arranged to output data relating to a current event of the complex workflow process. The communications server is also arranged to receive inputted user data from the remote user terminal, relating to the current event. The system also comprises a data store for storing the complex workflow process, storing the output data relating to events of the complex workflow process and storing the inputted event-related user data in corresponding user data records. The data store also stores a set of event data rules, linked to the workflow process, that govern which output data is to be provided at each particular event of the complex workflow. In addition, the system comprises composing means, operable in accordance with the event data rules, for composing a collection of output data. The composing means being arranged to compose the collection of output data from predetermined event data, relating to a current event, from a database of predetermined event data and historical event-related user data from an appropriate user data record.

### FIELD OF THE INVENTION

The present invention concerns improvements relating to management systems and more specifically relates to a management system for controlling the flow of information. It is to be appreciated that the present invention is described in the context of an employment management implementation embodiment for convenience, but the present invention can also be applied to other technical fields of application, such as managing a complex industrial process where it is important to make valued judgements in the control of the process at any given time, or in training of management of complex industrial processes without exposure to the risks of incorrect controlling decisions.

### BACKGROUND TO THE INVENTION

The inventors of the present invention have identified a number of problems associated with management systems, for example those associated with human resource (HR) management systems. In solving these problems, the inventors devised an invention which has a broader applicability than just to human resource management systems. Nevertheless, the present invention is described in the context of a human resource management system below to assist in its understanding.

The role of the line manager, and the relationship between line managers, HR departments and employees, is under increasing pressure in many private and public sector organisations. This pressure is a result of a range of factors, including a move to flatter organisational structures, reductions in manager/employee ratios, the downsizing of many HR departments, changing working patterns and the increased regulatory burden faced by employers.

These pressures have resulted in inefficiencies and gaps within many human resources management systems. These management systems are aimed at managing processes including recruitment, performance management, training and development, absence management, disciplinary and grievance procedures, and the management of areas such as maternity leave, parental rights, disability and sexual discrimination.

It is cumbersome for managers to manage many of these processes because they must have a clear and complete understanding of the structure of the process that they should follow. For example, they must know what activities need to happen, in what order, and at what time, to enable the process to be completed successfully in accordance with relevant regulations and policies.

Managers also need to understand what their responsibilities are at each stage in the process (for example in order to give an employee due notice of a forthcoming disciplinary meeting) and what choices that they have to make at each stage (e.g. whether to issue a formal warning).

In addition, it is not always easy for managers to be able to access the relevant information to help them carry out their responsibilities and make appropriate choices. This could include legal and regulatory information relating to employment law generally or industry-specific regulations, their own organisation's laid-down policies and procedures relating to people management, information relating to an individual employee, and guidance or training content regarding to management skills and best practise.

There is currently no adequate solution, which provides managers with all of these elements in a convenient, easily accessible way. Most organisations use a combination of ad-hoc systems or processes to support managers in carrying out their human resource management responsibilities.

The lack of effective systems to support the implementation of people management processes creates a number of problems for organisations. Organisations that lack effective systems for supporting managers and enforcing HR policies result in an increased administrative burden for both line managers and HR professionals. As a result, line managers spend a large amount of time searching for information or creating their own content. This can lead to the duplication of effort which has already been expended elsewhere in the organisation (for example in creating a job description). In addition, HR professionals have to spend a lot of time answering simple information requests from managers and must spend time ensuring that each manager is following the policies which the organisation has agreed and this typically requires documentation to be completed to provide proof to that effect.

In addition, because organisations lack a reliable, easy-to-implement method of providing information to their managers at the point in time that the manager needs it, there is a lack of consistency and accuracy in the way that many people management situations are handled. Each manager makes his or her own interpretation or assumptions about the right way to handle a particular situation or to carry out a particular process. In some cases, the manager is not even aware that there is a policy governing what they should or should not do. This can severely undermine an organisation's efforts to implement good HR practices.

Employers also have to deal and work with an increasing legal and regulatory burden. Although many organisations have HR policies and processes which reflect the latest legislative position, the lack of effective systems for communicating and enforcing these policies means that compliance failures are increasingly common. One 2004 survey reported a 50% rise in employment tribunal cases in the previous five years. Over 90% of cases that reach Employment Tribunals are lost by the employer, the majority being because the organisation in question was judged not to have followed correct procedures.

Furthermore, because organisations don't have centralised systems for recording information relating to people management processes (other than in basic areas such as absence recording), a lot of information typically is not effectively recorded and as such is lost when managers leave or organisations are restructured. This undermines the organisation's efforts to implement effective performance management and development processes and can also lead to staff dissatisfaction and a high turnover in staff.

In addition, organisations lack systems to capture information generated by managers while carrying out their people management duties, therefore HR professionals and senior managers find it very difficult to monitor what is happening within the organisation and to know whether processes are being implemented effectively. This means that by the time senior managers become aware of a problem it is often too late and considerable damage has been done.

Cumulatively these issues have a significant cost to organisations, resulting in increased turnover of staff, ineffective employee development, lower productivity, significant amounts of time being time consumed with grievance and disciplinary procedures and employment tribunals. Furthermore, this has an impact on the amount of management time which is available to focus on improving the business and serving customers.

An object of the present invention is to devise a system that provides better support to line managers, while at the same time ensuring greater consistency and accuracy in the application of HR policies and procedures. None of the currently available approaches, including management training, e-learning, advisory services and in-house intranet developments, have effectively addressed this requirement.

Attempts which have been made to address the above issues are summarised below. In each case, no real solution to the above-identified problems has been realised, and many disadvantages with each of the prior art systems exist. Prior art systems include content-based systems, people-based systems, software tools and applications, and training and development services.

In a content-based system, organisations may make information relating to employment law and HR processes available to managers as static content. This may be in the form of a paper-based manual which sits on the manager's shelf, a set of Word documents sitting on a server, or a mix of electronic content formats made available via an intranet. Some of this information may be sourced from external Information Providers such as Croner or ConsultGEE. This method has a number of disadvantages. For example, because the content exists in a passive form, it relies on the manager, to be aware of the existence of those policies, procedures or other documentation that he/she should be consulting. Often a manager is not aware and, as such, defined human resource procedures are not followed, leading to the undesirable scenarios described earlier.

In addition, the content is often poorly structured, such that it is difficult to find the required information for the correct procedure to be followed. Therefore, because it is cumbersome for managers to locate, read and understand the required information content and because managers are usually busy, they often will neglect to find the relevant content and will not adhere to the defined procedures. Again this leads to the undesirable scenarios above.

Furthermore, there is often no active maintenance or version control of content within such a system. Therefore, managers may be using out-of-date and inaccurate information. This undermines the system and leads to a scenario where managers are less inclined to follow the defined procedures.

In people-based systems, organisations rely on HR professionals to provide a supporting role to line managers. This includes responding to requests for information by e-mail, providing advice over the phone, holding review meetings with the manager and attending employee meetings alongside the manager. This inter-personal support may be provided by internal HR resources or external HR consultant or advice lines.

While this type of support will probably always have a role to play, there are some obvious limitations to it. The level of support available to managers will always depend on the number of supporting HR professionals and their availability at any point in time. In many organisations, HR departments are severely stretched and they are physically unable to provide the level of personal support that line managers require.

Many support requests from line managers to HR departments are standard and do not require ‘consultative’ advice but the simple provision of information. HR professionals responding to routine enquiries about processes or policies, is not an efficient use of resources.

Processes and policies within an organisation are still open to personal interpretation by individual HR professionals with the result that there is considerable scope for human error. In large organisations, the HR professionals involved in providing day-to-day support to managers, may have had little or no involvement in the formulation of policy and therefore may not have an in-depth understanding of it. Therefore, there is scope for inconsistent and incorrect information to disseminate from an HR department within an organisation.

Some software applications addressing the general area of people management exist and fall into two main categories namely, broad HR Management systems and systems focused on specific people management processes. These are discussed below.

Taking the first of these, there are a large number of HR Management system software applications on the market, many of which originated as Payroll management systems. Several common limitations exist with these systems in relation to the problems outlined above. They are focused on supporting HR departments and the management of employee records rather than supporting the role of line managers. Where these systems do provide access to line managers, it will typically be to view/update employee records rather than to support their workflows. Many of the problems identified above exist as line managers do not have easy access to the relevant information regarding the organisations processes.

Software applications are available, which attempt to support specific people management processes, including Appraisal and Absence Management Systems. These applications are designed to support only one specific process. In so doing, they are only providing a very partial solution to an organisation's HR management requirements. The present inventors have appreciated that, people management processes do not, in reality, exist in isolation from each other. For example, an appraisal process will be impacted by, or will impact, the recruitment process, training and development processes, absence management and disciplinary and grievance processes. If the information populating the appraisal system does not flow to and from other people management processes, the effectiveness of the system is severely limited, and many of the problems described above still exist. Despite this seemingly apparent limitation of prior art approaches, none of the prior art systems have sought to address this in a comprehensive manner.

Furthermore, because these limited systems only support a narrow element of the whole ‘employee lifecycle’ there can be an increase in the administration overhead as data often needs to be duplicated, refined and or manually transferred between different systems.

There are some management training and development solutions that are aimed at improving the effectiveness of line managers. These include workshop-based training, e-learning services, development centres and distance learning packages. In addition, many organisations have their own training and development functions that will offer programmes designed to improve the skills, knowledge and awareness of managers. However, most management training is delivered at a discrete event or a series of discrete events, which are separated, both physically and in time, from the actual activities to which the training relates. The ‘take-away’ from a training course is often a large, ring-bound folder containing paper copies of all the course content. Research has shown that much classroom-delivered training fails to meet its objectives because the knowledge is not applied immediately, if ever. The manager may not need to apply the knowledge until months or even years after the training event, in which case it is highly unlikely they are able to recall the specific detail that they require.

Furthermore, training and development activities are only geared towards imparting knowledge to managers and improving their competence to perform certain tasks. They do not offer any solution to an organisation's need for better management of employee information, improved enforcement of policies or better visibility and auditability of management processes.

One of the objects of the present invention is to provide a management system that enables more effective and consistent management of the flow of information to the entities to be managed. It is another object to provide an improved training system for use in training the management of complex multidimensional workflow processes.

### SUMMARY OF THE INVENTION

According to a first aspect of the invention there is provided a management system for assisting a user in the management of a complex workflow process, the system being arranged to generate and record data regarding a sequence of events occurring over time constituting the complex workflow process, the system comprising: a communications server arranged to output to a remote user terminal, output data relating to a current event of the complex workflow process and to receive inputted user data from the remote user terminal, relating to the current event; a data store for storing the complex workflow process, output data relating to events of the complex workflow process and the inputted event-related user data in corresponding user data records; a stored set of event data rules, linked to the workflow process, that govern which output data is to be provided at each particular event of the complex workflow; and composing means, operable in accordance with the event data rules, for composing a collection of output data, the composing means being arranged to compose the collection from predetermined event data relating to a current event from a database of predetermined event data and historical event-related user data from an appropriate user data record.

The provision of predetermined event data relating to a stage in a workflow process together with historical user data addresses many of the above-described lack of context problems. The system is able to provide assistance to users by providing the context of the current event in relation to a series of previous events which have occurred. This aspect enables the management assistance provided to understand and mitigate the potentially damaging effects of unusual events occurring within a complex workflow. For example, in a human resources management context, a disciplinary action can be restrained if the historical user data indicates that the employee has otherwise had an exemplary work record, or can be amplified if the historical user data indicates a poor work record. Furthermore, the following of predetermined events in a workflow which is controlled centrally, enables better governance of procedures across multiple users and better compliance with regulatory requirements. This also addresses problems with prior art systems described above.

In a preferred embodiment, the system further comprises a workflow management means arranged to enable user customisation of the complex workflow process.

Typically, the workflow management means is arranged to use the inputted event-related user data to modify the events and the stored workflow process, such that the complex workflow can be at least partially re-configured.

Optionally, the workflow management means is arranged to modify the events of the stored workflow process within a fixed overall framework. By enabling such limited modification of the workflow process, the process can both comply with best practice and regulatory constraints whilst at the same time advantageously providing a good degree of flexibility for the system to be tailored to individual local requirements.

Preferably, the composing means comprises a script generator arranged to utilise the historical event-related user data and the event-related user data to generate a script of information relating to a current event.

In one embodiment, the script generator may be arranged advantageously to generate a script comprising a sequence of instructions.

In a further embodiment, the script generator may be arranged beneficially to generate a script comprising a series of questions from which inputted user data is to be generated.

Preferably, the composing means comprises a document generator, the document generator being arranged to enable the user to construct text-based documents for use in the implementation of the complex workflow process.

In a preferred embodiment, the system further comprises output arranging means configured to arrange the output data to be presented on the remote user terminal.

Typically, the output arranging means is arranged to determine the format of the output data.

Preferably, the output arranging means comprises a workflow tuner engine arranged to determine the arrangement of supplemental output data to be output to the user with the output data in accordance with the current event in the workflow process and a stored set of supplemental information rules. Supplemental information is highly advantageous in that it assists the user to take informed management decisions. The supplemental output data can also be the most up-to-date assistance available.

Advantageously, the workflow tuner is configurable by a first user to determine the types of supplemental output data to be providable to a second user.

Typically, the output arranging means is configured advantageously to arrange output data into a graphical user interface (GUI) for presentation on the remote user terminal.

In a preferred embodiment, the output arranging means is configured to arrange output data into a GUI comprising a menu region for navigating different functionality of the system, a working region for display of the collection of output data relating to a current event of the complex workflow process and a supplemental information region for output of the supplemental output data.

In addition, the system may further comprise a menu manager for compiling a hierarchical menu for display in the menu region of the GUI, the menu enabling user selection of a specific part of the complex workflow process.

Preferably, the menu manager is arranged to consider the user's data record and generate a customised hierarchical menu for output to the user.

Typically, the system further comprises a content management engine arranged to permit user configuration of the output arranging means to integrate appropriate content with events in the complex workflow process.

Preferably, the content management engine is arranged to integrate content that is specified by the event data rules as mandatory information relating to the event.

Advantageously, the content management engine is arranged to permit user configuration of a subset of the stored event data rules. Again this enables the system to be more flexible and allows it to be tailored to user's specific preferences.

In a preferred embodiment, the system further comprises linking means for linking events in the complex workflow process to relevant information, stored in the system.

Typically, the relevant information is at least one of the set comprising: guidance notes, links to worked examples, and links to related documents.

In a preferred embodiment, the system further comprises a search engine, wherein the output arranging means is configured to enable access to the search engine.

In another preferred embodiment, the system further comprises a security subsystem arranged to control remote user access to information stored in the system by determining permission rights of a remote user.

Preferably, the security subsystem is arranged to control what predetermined event data information is provided to the composing means, the control being determined by the permission rights of the user.

Typically, the security subsystem is arranged to control a user's ability to modify stored data of the system.

In a preferred embodiment, the security subsystem advantageously further comprises an audit trail means arranged to record a remote user's interaction with the system.

Preferably, the audit trail means is arranged to note each data element created by the user interaction with the system.

Typically, the audit trail means records a date of creation and an author, for each data element in the system, and records a date and author of subsequent amendments to data elements within the system.

In a preferred embodiment, the system further comprises a reporting means arranged to generate reports of user interaction with the system using at least one report template.

Advantageously, the system is arranged to manage a set of workflow processes.

Typically, the set of workflow processes relate to a set of users.

Preferably, the system is arranged to manage a plurality of workflow processes, each workflow process being independent of another workflow process.

Typically, the system is arranged to manage a plurality of sets of workflow processes, each set relating to a different set of users.

In a preferred embodiment, the system further comprises competency framework generation means for generating a competency framework of attributes, wherein attributes are associated with one or more entities and one or more events, and wherein the composing means is arranged to use the competency framework of attributes to select relevant output data relating to the attributes within a current event of the workflow process.

The competency generation means may advantageously be configurable by a first user for application by a second user. In this way, control from an administrator of the management process may be facilitated.

The output data may comprise at least one data element, wherein a data element is one element of the set comprising: a text document, a hyperlink, a video file, an image file, an HTML file, and an Audio file.

Preferably, the system further comprises an alert generation means arranged to consider the received event-related user data with respect to the set of event data rules and to generate and send an alert notification via the communications server to the at least one remote user terminal if an action associated with an event has not been taken, or if required data relating to an event has not been received at an appropriate stage of the workflow process. The alert generation means advantageously provides assistance to users in management of entities particularly when the management is occurring over a long time period and is it possible to overlook taking particular actions.

The present invention also extends to a combination of a management system as described above and at least one remote user terminal operatively connectable to the server via a communications network. Such a distributed system enables central management over a wide area.

According to another aspect of the present invention there is provided, a method of assisting a user in the managing of a complex workflow process, the method including generating and recording data regarding a sequence of events occurring over time constituting the complex workflow process, the method comprising: outputting to a remote user terminal, output data relating to a current event of the complex workflow process; receiving inputted user data from the remote user terminal, relating to the current event; storing the complex workflow process, output data relating to events of the complex workflow process and the inputted event-related user data in corresponding user data records; using a set of event data rules, linked to the workflow process, that govern which output data is to be provided at each particular event of the complex workflow; and composing in accordance with the event data rules, a collection of output data from predetermined event data relating to a current event from a database of predetermined event data and historical event-related user data from an appropriate user data record.

According to another different aspect of the present invention there is provided a management system arranged to enable managers to record information relating to a plurality of different events occurring during an employment time period, where the system is arranged to utilise stored data to effect best practice in data recordal and advice provision regarding each particular event during that time period including providing user-recorded information relating to a previous event in relation to a current event. Within a human resources management environment, this aspect of the present invention provides significant benefits over the known prior art systems.

Preferably the user-recorded information is provided in accordance with a set of stored rules, which govern how user-recorded data relating to previous events and predetermined data are to be presented to a user during a particular current event.

According to a yet further aspect of the present invention there is provided, an alert notification system for assisting a user in the management of a complex workflow process, the system comprising: a data store for storing a complex workflow process comprising a sequence of events occurring over time, and a set of event data rules, linked to the workflow process, that govern how users interact with the workflow process at each particular event; a data input means to receive event-related user data from a remote user terminal during interaction with the workflow process, and an alert generation means arranged to consider the received event-related user data with respect to the set of event data rules and to generate and send an alert notification to the at least one remote user terminal if an action associated with an event has not been taken, or if required data relating to an event has not been received at an appropriate stage of the workflow process.

The advantages of alert notification have been described above, but within any complex workflow process, users require as much assistance as possible. In the present case such alerts can be highly advantageous in insuring workflows are correctly followed.

Preferably the alert generation means is arranged to be configurable by a first user for use by a second user. This enables administrators to configure the system for use by managers of entities in a uniform and consistent manner.

The appropriate stage of the workflow process may comprise a predefined time period of the workflow process.

There are several different ways of communicating the alert. For example, the alert may be sent via an e-mail to the at least one remote user terminal or a notification of the alert may be displayed on a home page of the user's remote user terminal.

The present invention when used within a human resource application, advantageously increases the productivity of managers, employees and HR professionals, raises manager and employee job satisfaction levels, and improves the implementation of and adherence to HR policies and regulatory requirements. As a result, the costs associated with compliance failures is reduced. In addition, the present inventions advantageously enable organisations' HR professionals and management to obtain better visibility of processes and performance within their organisation.

### BRIEF DESCRIPTION OF THE DRAWINGS

The present invention will now be described with reference to the following drawings relating to an exemplary embodiment, in which:

FIG. 1 is a schematic diagram detailing a number of people management processes to be managed by a management system according to a first embodiment of the present invention;

FIG. 2 is a flow diagram showing a simplified workflow relating to the recruitment process from FIG. 1;

FIG. 3 is a schematic block diagram showing the architecture of the management system of the first embodiment of the present invention;

FIG. 4 is a schematic block diagram of the structure of a database of the system shown in FIG. 3;

FIG. 5 is an example screenshot exemplifying a graphical user interface of the management system of FIG. 3;

FIG. 6 is a screenshot showing an example of information recorded by an audit trail module of the management system of FIG. 3;

FIG. 7 is a schematic block diagram of a server of the management system of FIG. 3, showing five of its subsystems;

FIG. 8 is a screenshot showing a permission set table of the management system of FIG. 3;

FIG. 9 is a partial screenshot showing an additional information region of the graphical user interface of FIG. 5 comprising sections relating to guidance notes, related documents and example documents;

FIG. 10 is a screenshot showing an example of a competency framework of the management system of FIG. 3, which is used in performance management;

FIG. 11 is a screenshot showing an example of how a competency framework shown in FIG. 11 is set up;

FIG. 12 is a screenshot showing an example of setting up competencies of the framework shown in FIG. 10, which are required for a particular job role;

FIG. 13 is a block diagram showing the operation of an alert notification subsystem of the management system of FIG. 3;

FIG. 14 is a screenshot showing a Summary Page for an employee including general notes, performance management information, absence data and previous performance review data;

FIG. 15 is a screenshot showing a disciplinary process summary including links to related documents;

FIG. 16 is a screenshot showing how a manager's review support pack is created; and

FIG. 17 is a flow diagram showing a typical HR workflow relating to FIG. 1 and encompassing the recruitment process of FIG. 2.

### DETAILED DESCRIPTION OF AN EXEMPLARY EMBODIMENT OF THE PRESENT INVENTION

The present embodiment, which is directed specifically towards a non-limiting application of human resource management, contains a combination of workflow tools, database technology, reporting tools and supporting content delivery mechanisms, which are designed to integrate many of the administrative processes associated with people management. These same elements could readily be used in other management applications to provide benefit to users as will be described later. This integration offers the advantage that the administrative processes are simplified, automated, more efficient, and more consistent.

The present invention is described below in relation to a specific embodiment concerning a human resources application. It is to be appreciated that this is a non-limiting example and that the present invention could equally apply to any management system. For example, a management system which assists in the control of a large production line where several complex processes must be carried out. Alternatively, the present invention could be provided as part of a training device for the management of a complex process, for example as part of a management/control simulator, where a user's decisions are to be based on a set of information relating to a current status of a complex process and also on historical data concerning previously executed tasks and events which have occurred.

The present embodiment provides line managers with structured, step-by-step processes for carrying out many of the typical tasks associated with people management, accessed via a simple, easy-to-use interface. The present embodiment delivers relevant or mandatory content to line managers at the appropriate point within the process. Content can include text-based documents, presentations, spreadsheets, diagrams and short audio/video clips. In addition, the present embodiment generates customisable e-mail alerts notifying managers or HR professionals of key milestones or tasks according to pre-set, organisation-defined parameters. This embodiment also provides companies with a single repository for all content relating to their employee management processes and policies, enabling easier management and maintenance of the information. Furthermore, the present embodiment enables easy access to a consolidated employment history for each individual employee, including interview notes, appraisals, training, attendance, absences, disciplinary meeting notes etc, provides an audit trail for all key employee management events, and provides tracking and reporting tools to senior managers and HR departments, giving them greater visibility of line management activities. Also the transfer of information between the various line management processes is made easier by the present embodiment to ensure greater consistency and continuity in management performance. Further advantages are achieved by the present embodiment providing customisation tools to enable each organisation to tailor the processes and content to reflect their own policies and procedures, and to reflect their own company branding. Also comprehensive administrative tools are offered to enable users to manage easily content and manager/employee hierarchies.

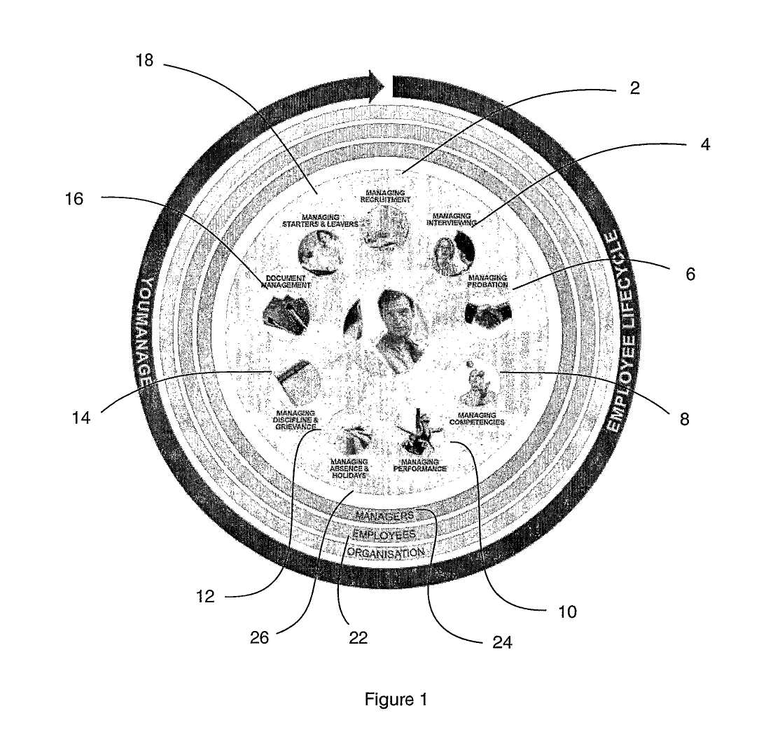

Referring now to FIG. 1, there are shown nine people management processes which a system of the present embodiment can be used to manage including managing recruitment 2, interviewing 4, probation 6, competencies 8, performance 10, absence and holidays 12, discipline and grievance procedures 14, document handling 16, and starting and leaving employees 18. The management of these processes effects the organisation 22, and the employees 24 and managers 26 within the organisation 22. Key stages in the employment and management of employees are typically standard.

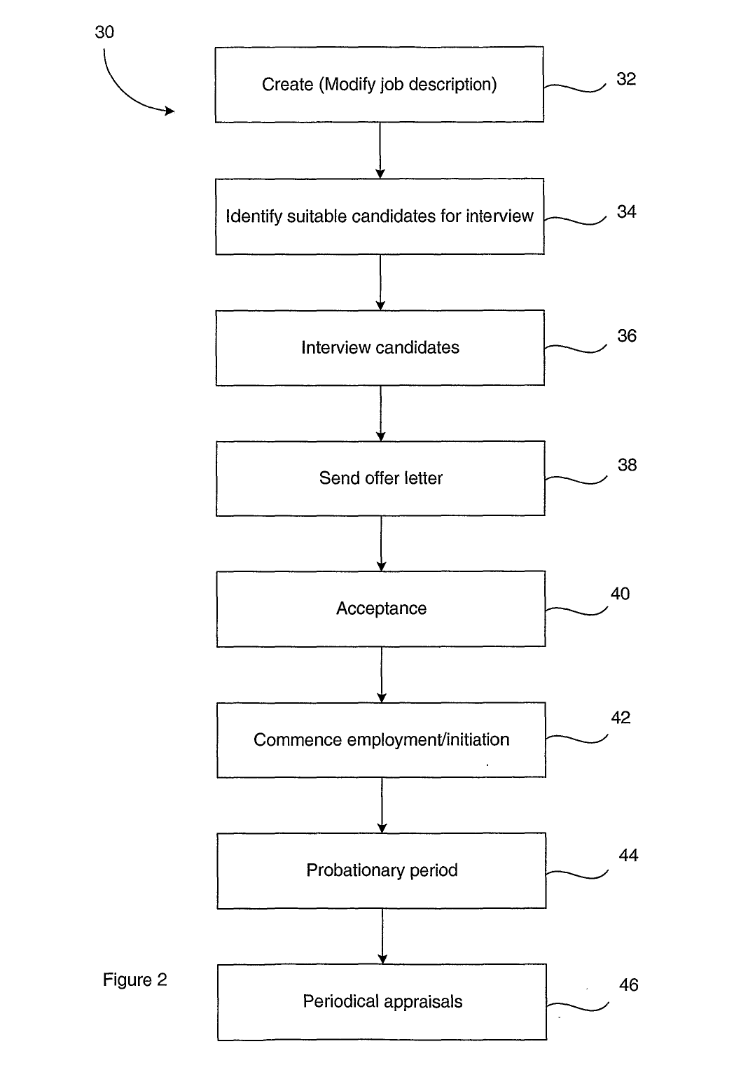

The system is tasked with the management of these processes and a vast array of associated information. In order to manage these issues, workflows/workflow models are used to assist with the management of documentation, information and work processes/tasks. Workflows typically provide a structure and sequencing to tasks/events which are to be executed. FIG. 2 shows an example of a simple workflow model 30 of the recruitment process. Each of the steps within FIG. 2 also has an associated workflow (not shown). A more typical workflow is described later.

At Step 32 of FIG. 2, a manager, responsible for recruiting new staff to undertake a certain role within the organisation, must first create a job description for that role. Furthermore, a job description is subject to change from time to time. When the job description is created a manager (who may or not be the same manager who created the job description at Step 32) must, at Step 34, take steps to identify suitable candidates for interview and then subsequently, at Step 36, interview the identified candidates to ascertain their suitability to fulfil the required job description. If successful at the interview, an offer letter is sent to the prospective new employee at Step 38, and if they accept at Step 40, they will be commence employment and complete an initiation phase at Step 42. Once recruited, an employee is subject to a probationary period throughout which they are monitored, at Step 44, to ascertain if they have demonstrated their suitability to fulfil the job description generated for their role within the organisation. Furthermore, periodically an employee is assessed, at Step 46, through appraisals with at least their line manager to assess their continued suitability for the role for which they are employed.

In addition to the key employment stages above there is further information, which a line manager, responsible for particular employees, may be required to know about. Further information fields include: absence records, induction data for new employees, procedures for staff leaving place of employment, procedures for temporary staff, parental rights, recruitment policies, redundancy policies, disciplinary procedures, and grievance procedures. Of course, it is to be appreciated that the above list of further information fields is not exhaustive.

There is a vast amount of data generated for each employee in an organisation relating to each of the key stages and further information fields identified above. All of this data is stored within the system and is used as appropriate at different stages in the workflow. By providing relevant information at a particular point (event) in a workflow the user is able to make best informed management decisions because they are provided with a complete picture of the relevant information.

A disadvantage associated with the use of workflows relates to the fact that not every manager adheres to the defined workflows and there may be a lack of knowledge relating to each workflow since this data can be cumbersome and difficult to keep up-to-date with if changes are commonplace or working to a particular workflow is not a common task for a manager to complete.

The present embodiment utilises a complex, multi-dimensional workflow process in an integrated management system in order to ensure consistent treatment of employees, which complies with the necessary employment law regulations, through an integrated management system. This compliance is achieved by providing instructions or taking some action at an appropriate event to ensure the manager is prompted to follow a specific procedure.

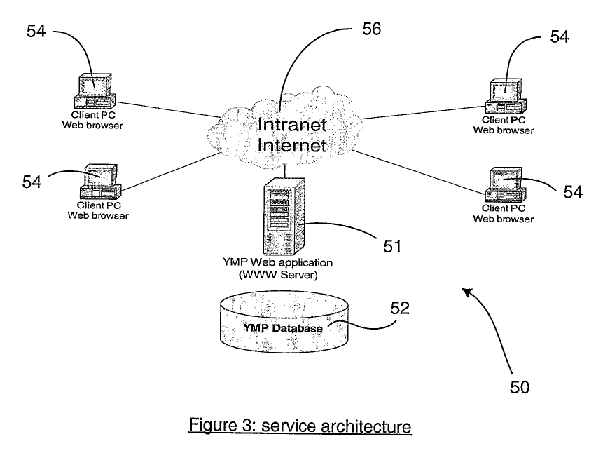

The architecture 50 of the system of the present embodiment is shown in FIG. 3. The architecture 50 consists of a server 51 (protected by a firewall) and a database 52. In addition, a plurality of remote user terminals 54 are connected via the Internet 56 to the server 51.

The server 51 hosts a web application, which provides a graphical user interface (GUI) 99 through which a user can interact with the system of the present embodiment. In this regard it is to be appreciated that the GUI is simply generated at a user's remote terminal via a standard Web browser window. The GUI 99 displays information to the user, provides several selectable options, and provides data entry fields as appropriate.

The database 52, in one embodiment, is a single MICROSOFT SQL® database, which is accessed by the server 51. As such, employee-related data created at any point during the employee lifecycle can be accessed at other key points in the lifecycle, enabling far greater integration across management processes.

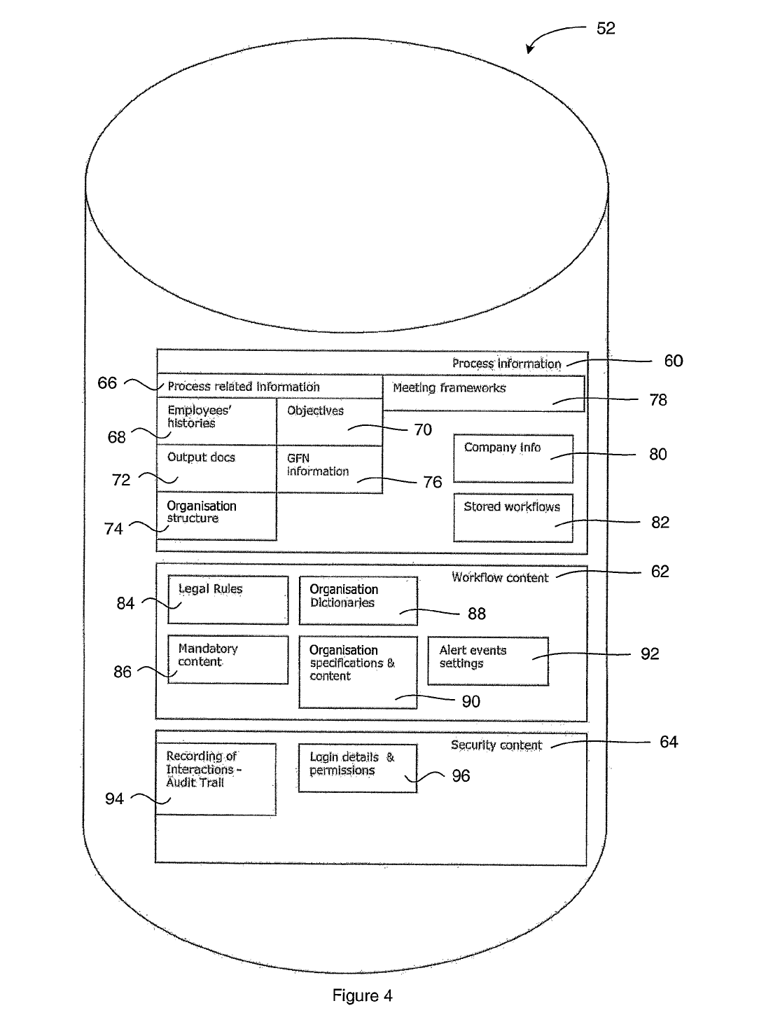

FIG. 4 shows the structure of the information within the database 52. As shown, the types of information stored include: process information 60, workflow content 62 and security content 64.

The process information 60 includes process-related information 66, employees' histories 68, objectives 70, output documents 72, organisational structure information 74, General File Note (GFN) information 76, meeting frameworks 78, company information 80 and stored workflows 82.

The workflow content section 62 of the database 52 includes legal rules 84, mandatory content 86, organisation dictionaries 88, organisation specifications and content 90 and alert events and settings 92. The security content 64 includes recording of interactions (audit trail) 94 and login and permissions of users 96.

The server 51 and database 52 are arranged to operate with remote terminals 54 associated with many different organisations 22. The structure of the database 52 described above is repeated for each different organisation 22, i.e. each organisation 22 has their own instance of the database 52 having a pre-defined structure. The content in an organisation's instance of the database is unique to that organisation 22. In addition, each organisation 22 can tailor the system to meet their requirements.

The system enables system users (line managers, senior managers or HR professionals) to have very quick and easy access to comprehensive information relating to an individual employee via a consolidated summary, enabling the user to easily drill-down into individual records relating to a particular employee.

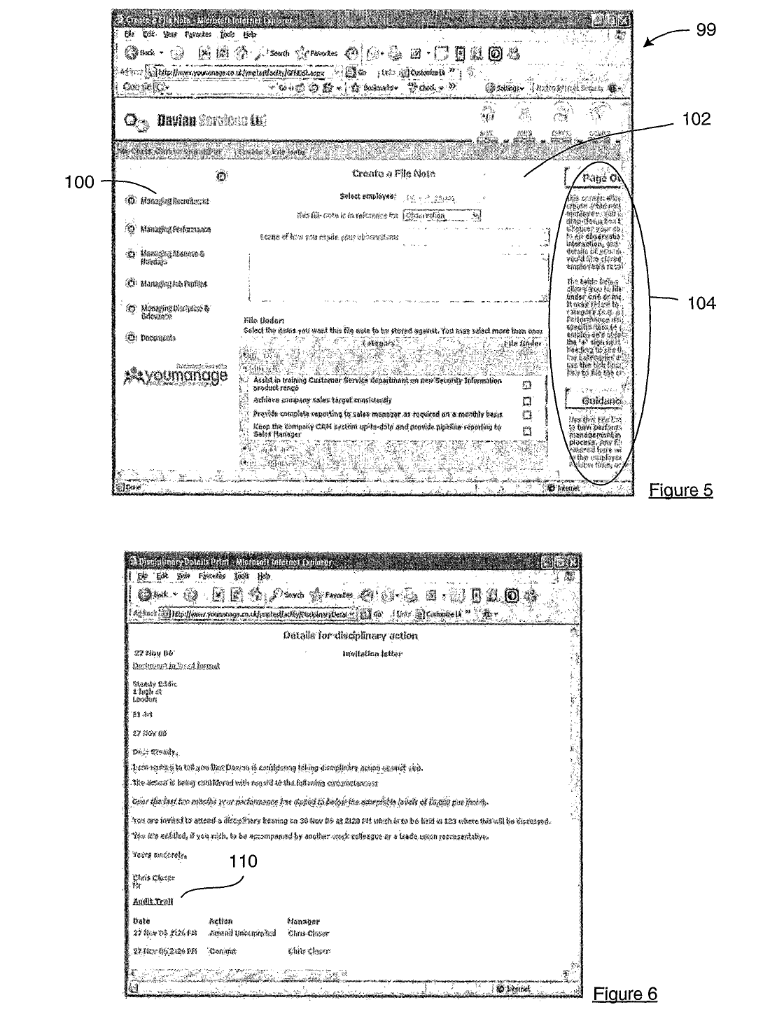

As shown in FIG. 5, the GUI 99 (see FIG. 5) provides three main screen regions, a Menu region 100, a Working region 102, and a Guidance Area/Additional Information region 104. The Menu region 100 shows a hierarchical menu for navigation through the system. The Working region 102 displays information relating to a current event in a series of events in the workflow, in this case the current event is the creation of a file note through a template. The Additional Information region 104 (partly visible in FIG. 5) displays additional support content which is generated by a workflow tuner described in detail below.

Due to the nature of human resource management within an organisation, a number of different users with different requirements for information and different permission rights may require access to the system, ranging from line managers who require use of the system in the course of their normal duties relating to managing the people in their team, to managers at a higher level who require use of the system to monitor the effectiveness of the management of the people within the organisation, i.e. how line managers manage the people in their team, for example, ensuring that appraisals are carried out. Other users include HR professionals who require use of the system to provide central management of certain aspects of people management processes (for example, to ensure consistency across multiple Job Descriptions) and to access reporting information on the number and status of active people management events; and System Administrators who are responsible for configuring the system to their individual organisation's requirements.

Furthermore, given the importance and personal nature of the information regarding employees of the organisation, access to the information is restricted as necessary, such that only users, who have a requirement as part of their role within the organisation can access, edit or add information to an employee's data records.

Administrators within each organisation configure the system to meet the needs of their organisation, and this includes controlling user access to the data within the system, as required. For example, line managers are given access to enable them to view/edit/add to/delete a subset of the employee data records relating to the employees under their chain of command, while senior managers may be given access to all of the employee data records.

Each user within the system is allocated a unique login name and password by an administrator of the system. Thereafter, the administrator or a user with suitable permission rights configures each user account with the necessary permission rights.

The system enables management of the various types of documents related to employees. The system enables the documents to be stored in the database 52, controls user access to the documents, records an audit trail of the user's interaction with the system, and provides tracking of workflows. Tracking workflows enables senior managers or HR professionals to track the current status of an individual workflow process being carried out by a manager (for example, a Disciplinary Action). In addition, the system maintains a record of the evolution of certain aspects of the workflow framework contained within the system, which can be referred back to if necessary.

The system provides a mechanism to enable individual users within organisations to generate HR documentation (e.g. Disciplinary letters) according to pre-defined structures, to ensure that it complies with best practise. This would include, for example, a script for a disciplinary meeting or a letter that has been sent to an employee. The user is taken through a series of steps to create the document—in each step the user is presented with sample content based on best practise examples which the user can edit to suit the specific situation. This approach ensures that the document contains the appropriate elements and is structured correctly.

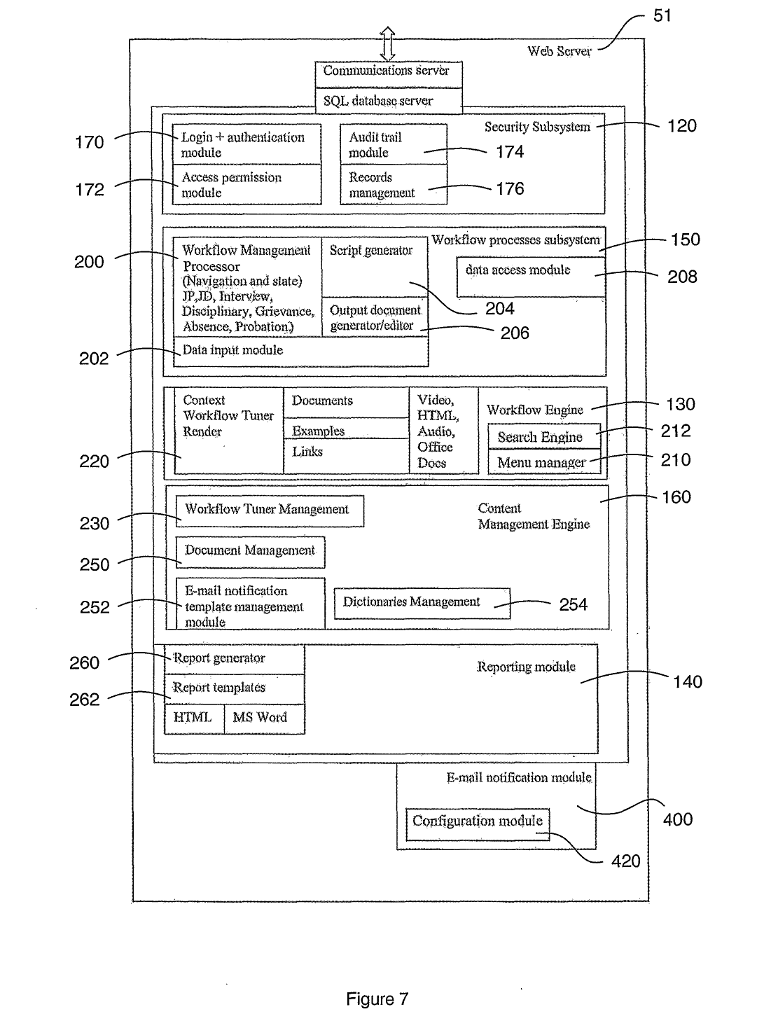

Once created this documentation is stored along with a record of when it was created and by whom. The individual record or document cannot then be edited by the individual user. This facet of the system means that organisations have a detailed audit trail 110 for key people management activities, which helps in resolving disputes, particularly those that could reach a court of law or an employment tribunal. The audit trail 110 can also help organisations in certain industries meet their regulatory compliance obligations. An example of the information recorded by an audit trail module 174 (see FIG. 7) is shown in FIG. 6. Also in other embodiments where the system is being used as part of a training device/simulator, the audit trail 110 is very important in helping to retrace a user's steps through a particular section of the complex workflow. In this way, the audit trail module 174 can be used by a trainer to show a user how they should have reacted correctly at every step of the workflow and also mistakes can be highlighted.

Referring now to FIG. 7, the server 51 of the system comprises five main subsystems, namely: a security subsystem 120, a workflow engine 130, a reporting module 140, a workflow processes subsystem 150, and a content management engine 160. Each of these subsystems is now described in turn.

As shown in FIG. 7, the security subsystem 120 incorporates a user login and authentication module 170, an access permission module 172, the audit trail module 174 (mentioned earlier) and a record management module 176. These modules operate together to authenticate the identity of each user, in accordance with their login and password details, and to restrict access to the modules and documents which the user has the necessary permission rights to access.

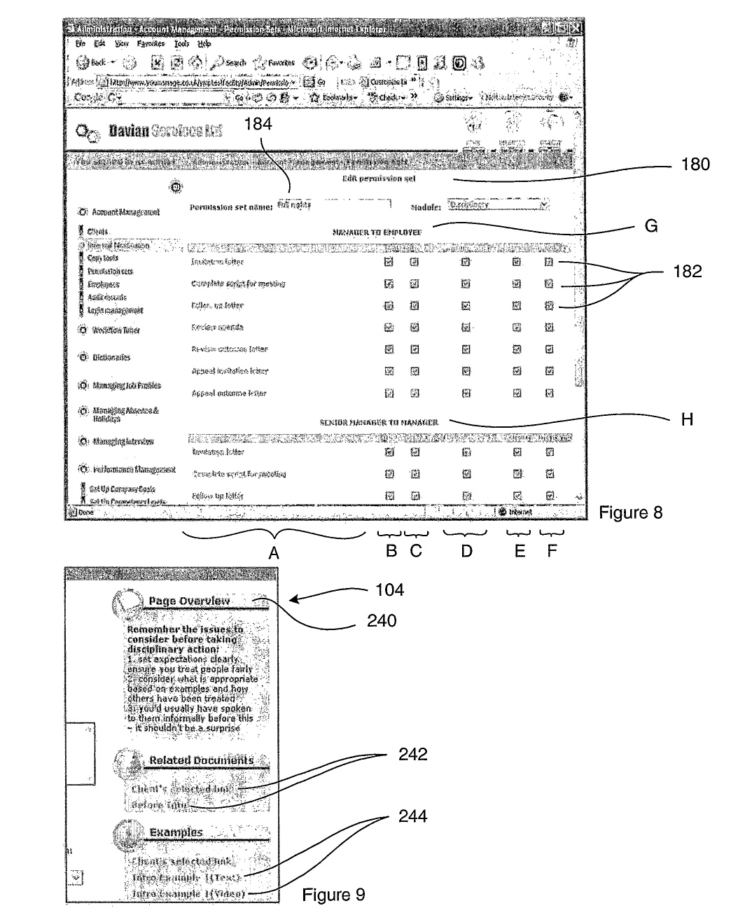

In the present embodiment, permission rights are controlled using a permission set table 180 generated by the access permission module 172, an example of which is shown in FIG. 8. As shown in Column A, a list of different events (e.g. invitation letter) are given, and along columns/actions B to F, check boxes 182 are provided corresponding to different actions (read B, create C, amend uncommitted D, commit E and rollback F). Whether a check box 182 is checked determines whether permission to take the action relating to a particular event is granted, in the example shown, for a user who is signed in as an administrator. Permissions are granted in relation to the seniority of the person initiating the action and the seniority of the recipient of the action, for example, from manager to employee G, or senior manager to manager H. Permission sets 180 may be created and saved under a particular name 184 to the database 52 to be re-used. Very specific permission rights may be granted in this way.

A user at a remote terminal 54, wishing to use the system, is presented via the GUI 99 with a login screen generated by the login and authentication module 170, into which they must enter their login name and password details. The remote terminal 54 generates a request which is sent to the security subsystem 120 of the server 51. The login and authentication module 170 within the security subsystem 120 handles the request and verifies the user's existence, and determines the user's permissions, by looking up the user's login details and permissions table 96 within the security content section 64 of the database 52.

The access permission module 172 allows users with the relevant access permissions (for example, a user with an administrator access level) to create and manage other users within the system and to create, edit and view certain documents. A user must be verified by the login and authentication module 172 and also must have the necessary permissions in order to access the documents and undertake permissible actions.

Several access/permission levels are presented in the system, and each user is associated with a specific access level. Typically, users with higher access levels have access to documents and records created by users with lower access levels. However, users with low access levels will not have the required permissions to view documents created by users with higher access levels.

Permission rights also determine what actions users can take in response to the current event. Organisations will typically allocate different levels of authority to different types of manager to carry out different actions in relation to a people management process. For example, one manager might have the ability to carry out interviews, but not have the authority to approve a hiring request. Alternatively, one manager may be authorised to initiate a disciplinary procedure but not actually generate a letter to dismiss an employee.

The audit trail module 174 keeps a log of each users' interaction with the system and stores a record of documents that the user creates or edits and certain actions that the user carries out. An audit trail of each users' input, in relation to a particular employee or document or business process, is stored in the recordings of interactions area 94 of the database 52 and can be referred back to when required. The audit trail is stored indefinitely unless specifically deleted by a user with the highest relevant permissions. However, typically these audit trails are not deleted.

The records management sub-system 176 provides ‘case management’ functionality through a Process event or series of events by linking multiple individual pieces of data as part of one overall record. This enables users to get a complete view of a Process event and also enables data created separately from the workflow process (e.g. a File Note for an employee) to be linked to a specific process record (e.g. for a Disciplinary action).

The management system permits workflows to be generated and updated as necessary, and for the information associated with a current event in a current workflow to be accessible to a user with the necessary permission rights. The workflow processes subsystem 150 and the workflow engine 130 enable the management system to provide this functionality.

As shown in FIG. 7, the workflow processes subsystem 150 comprises a workflow management processor 200, a data input module 202, a script generator 204, a document generator 206, and a data access module 208.

The workflow management processor 200 has a workflow core structure relating to human resources. The core structure incorporates each of the people management processes 2, 4, 6, 8, 10, 12, 14, 16, 18 described above, and the workflows core structure provides a working structure for the system. The core structure is not alterable by an organisations administrator because certain parts of the workflow may be fixed by regulatory requirements relating to employment laws. However, it is possible for individual organisations to tailor certain processes and change the resultant events within the workflow to meet their needs. Of course, as laws and regulations change the workflow core structure is updated centrally to ensure that all organisations comply with revisions in the law.

A user with an appropriate access level, for example, an administrator, tailors the workflow using a template or similar workflow. Tailored workflows can continue to be added to or modified over time as demands and requirements change.

The workflow tailored to the organisation ensures that treatment of employees is consistent across the organisation and that the workflow itself mirrors the organisations HR management requirements.

In the workflow processes subsystem 150, the data input module 202, script generator 204, and document generator 206 operate in accordance with the current event. Information relating to the current event is displayed in the working region 102 of the screen and assists the user in carrying out certain tasks associated with the current event.

The document generator 206 is arranged to allow for the building of text-based documents, which can then be further edited by individual users during various other processes.

For example, if the current event is ‘initiate new grievance procedure’ the user is presented with a template, which they complete to carry out their task. A workflow associated with a grievance procedure may comprise using the document generator to generate a letter to the employee concerned regarding the grievance procedure; and may also involve the script generator generating a script for a disciplinary meeting. Such a script may well set out a prepared structure of the meeting and points to be covered.

The workflow processes subsystem 150 advantageously assists the manager in performing his/her task and improve consistent treatment of employees across the organisation.

Both the document generator 206 and the script generator 204 receive content entered by the user, via the data input module 202, and stored content accessed via the data access module 208.

The data access module 208 is a gateway between the current event and the pre-stored content relating to the employee and the management process, which the current event concerns and which is stored in the database 52. For example, while going through the workflow of preparing for a disciplinary meeting the data access module 208 can be used to access and retrieve, from the database 52, the employee's attendance and time-keeping records which are stored in the employees' histories area 68 of the database 52. The document generator 206 and the script generator 204 are enabled to generate the necessary documents using MICROSOFT WORD® Word or other suitable word processing programs. The workflow engine 130 controls access to various workflow resources 82 stored in the database 52. The workflow resources/data elements include document examples, links, video, HTML Audio and Office documents. The functions of context and rendering of content is handled as is the workflow tuner itself, which is described in greater detail below.

The workflow engine 130 also comprises a menu manager 210 that provides the hierarchical menu, which is displayed in the menu region 104 of the GUI 99. The menu manager 210 determines which menu options appear for each different organisation depending on how the service has been set-up. In addition, an administrator can configure the menu options for different users within the organisation based on the permission rights that have been accorded. For example, an administrator will be provided with menu options which are different from other users.

A main menu of the hierarchical menu contains each of the people management processes detailed above, i.e. managing recruitment 2, interviewing 4, probation 6, competencies 8, performance 10, absence and holidays 12, discipline and grievance procedures 14, document handling 16, and starting and leaving employees 18.

Each item in the main menu, when selected, results in an associated sub-menu being displayed. For example, under the main menu option for discipline and grievance procedures, a menu containing selectable options for ‘view pending grievance procedure’ and ‘initiate new grievance procedure’, may be displayed. Other options may also be displayed under the discipline and grievance procedures menu.

Selection of menu options results in a current workflow and current event being determined, i.e. in the above example the current workflow is the workflow associated with discipline and grievance procedures and if the ‘initiate new grievance procedure’ is selected then it becomes the current event.

In addition, the workflow engine 130 comprises a search engine 212, which allows users to search cases by various criteria (dates, employee or manager name, etc. . . . ). The search engine 212 returns a list of results which meet the search criteria entered into the search engine 212.

The workflow engine 130 also comprises the workflow tuner 220, which allows the user to be presented with instructions (policies and procedures) and guidance (for example, best practice tips) specific for the current event. The workflow tuner 220 provides the additional information content to be displayed in the Guidance Area/additional information region 104 of the GUI screen 99. The type of information presented to the manager includes HR policies, company communications material, guidance on how to complete certain tasks or examples of completed forms. The workflow tuner 220 is enabled to deliver to the line manager information in a variety of formats, including electronic documents (e.g. PDF, MS Office files), HTML content, video/audio files and links to other web sites.

The workflow tuner 220 operates in conjunction with pre-determined additional information rules, stored in the database 52, to control the information, which is to be presented in the Working Region 102 and/or the Additional Information region 104 of the GUI screen 99. For example, in the case of a user working through a Disciplinary Process, different Guidance information can be presented to them depending on what issue the Disciplinary Action concerns (e.g. Performance, Absence, Gross Misconduct). When a user selects an option from the menu, the current event displayed in the Working region 102 is updated. This, in turn, results in the updating of the information displayed in the Additional Information region 104.

The rules stored in the database 52 can be updated as required in order to fine-tune the workflow tuner 220 to provide better support. An administrator can configure the rules via a workflow tuner management module 230 (described below).

As shown in FIG. 9, the workflow tuner 220 displays in the Guidance Area region 104 of the GUI 99 additional information in the form of a page overview 240, guidance notes, links to related documents 242, and links to examples 244. All of the additional information is provided in order to assist the user with the requirements of the current event.

This offers the advantage that the information is easily accessible to the users at minimal effort, meaning that users are much more likely to follow set workflow procedures. The system advantageously provides a mechanism which enables organisations to easily define relevant or mandatory content to be integrated with the workflow process so that it is delivered to users at the specific point (event) within the process that the manager requires that information. The information displayed in the Guidance Area region 104 of the GUI 99 is defined for each individual screen within a Workflow process and is editable by each individual organisation.

The content management engine 160 comprises several management modules including: the workflow tuner management module 230 (mentioned earlier), a document management module 250, an e-mail notification module 252 for managing e-mail notification templates and a dictionary management module 254. The content management engine 160 is also provided to allow for the adding, storing and deleting of files (text documents, presentations, spreadsheets diagrams and short video clips) as well as changing the design of Web application pages.

The workflow tuner management module 230 permits configuration of the rules that govern the additional information, which is to be displayed in the additional information region 104 of the GUI screen 99, and the rules that govern the information, which is to be displayed in the working region 102 of the GUI screen 99 (for example text which is used to populate a letter template). The rules allow documents to be linked with certain events such that when an event is selected to become a current event within the workflow, and is displaying in the working region 102, content which is linked to the current event is displaying in the additional information region 104 and/or working region 102 of the GUI screen 99. Each piece of content, known as a data element, is stored within the database 52 in a location which maps to one or more appropriate processes or events within the workflow.

The reporting module 140 provides the ability to track processes in the workflows and also to report events as required, for example, the number of recruitment processes that are currently pending, or, the number of employees who are overdue a performance review. Tracking screens are provided in the GUI 99 from the Web application. They enable users at a high enough user level to have a summary of what is happening in the levels below. As well as a summary overview of what is happening in the levels below, it also allows that user to drill down to the specific audit trail 110 and the documents contained within that audit trail.

As well as tracking screens, the summary reports and charts (in HTML MICROSOFT WORD®, MICROSOFT EXCEL® or other appropriate format) are presented by the GUI 99. Modules such as the report generator 260, determine the set of tracking screens and reports using report templates 262.

As described above, the system allows the storage of text-based documents, presentations, spreadsheets, diagrams, audio files, short video clips and most other common file types (commonly referred to as resources/data elements) in the database 52 (shown in FIG. 4). In order to allow the creation and updating of such documents, as well as configuring the entire system for different organisations, the above-described functional components of the server can carry out content updating and uploading. The functional components which permit the content updating and uploading include the document generator 206, the content management engine 160, the access permissions module 172, and the workflow engine 130.

Integration with other HR systems is possible through an Application Programming Interface (API) like mechanism which enables plug-in connectors to be created that allow for the export and import of data in the system and to permit data stored in/required by other HR systems to be transmitted accordingly between the systems. Typically a specific connector will be developed for each HR system that there is a requirement to interface with, which will enable implementation of the export/import capability.

The management system also provides a mechanism which allows organisations to define comprehensive Competency Frameworks for their workforce and have this information presented to, and be accessible by, managers, in a format which does not require them to be aware of the existence of, or structure of the competency framework itself.

Competency Frameworks are being implemented in many organisations. The Competency Framework usually defines the overall competencies that are required within an organisation's workforce and the specific standards of competence that are required within each individual job role. The purpose of these Competency Frameworks is to inform the organisation's recruitment and development processes, by ensuring that they have people within each job role that have the necessary competencies to perform that role effectively.

The limitation of Competency Frameworks is that they typically exist as hefty Word documents, which are not easily accessible or digestible by individual managers. For a manager to know how they should apply a Competency Framework in a particular recruitment or development situation they will need to spend time reading the document to find the pieces of information that are relevant to them and then need to work out how it should be applied in that specific situation. Because of the inaccessibility of the information that exists within a Competency Framework they are often not used in practise by managers.

The management system advantageously provides a structure which enables an organisation to define their Competency Framework within the system and then to present to managers, during a current task, only the information that is relevant to them at that particular point in time. The competency Framework can thus be considered to be an information filter governed by competencies of the user. The competencies are stored within the system according to a pre-defined data structure, which is then correlated with other information (e.g. an Interview Script for a particular Job Role) to determine which information is relevant to an individual user at a particular point in time.

The system also facilitates different people within an organisation being responsible for different elements of the Competency Framework without losing its coherence and consistency. For example, one user could be responsible for defining the overall Competency Requirements for an organisation.

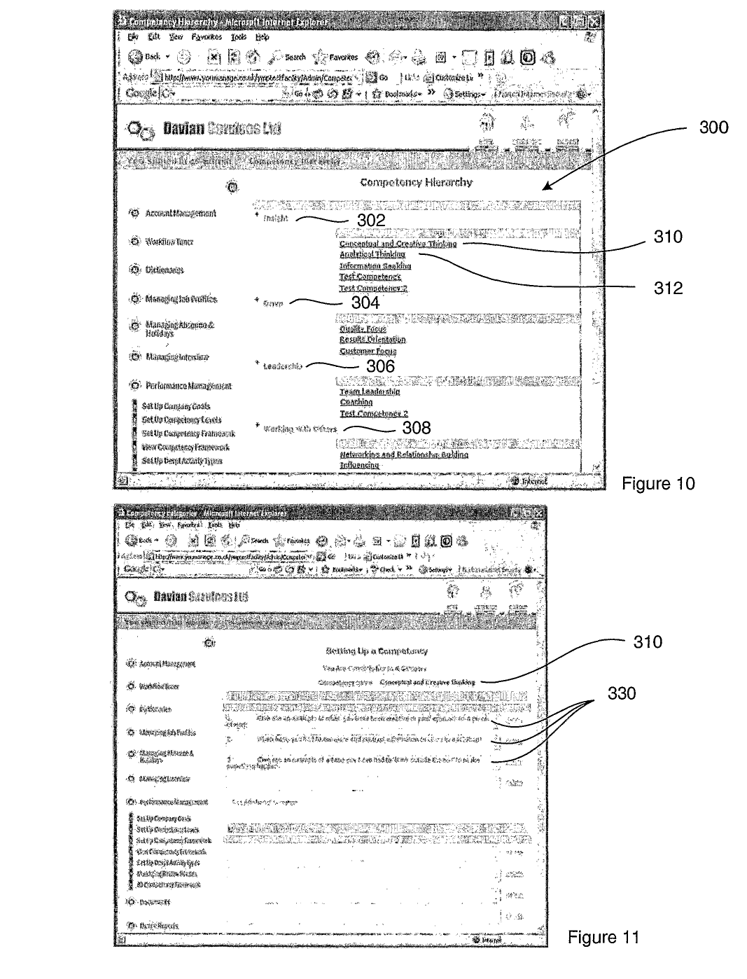

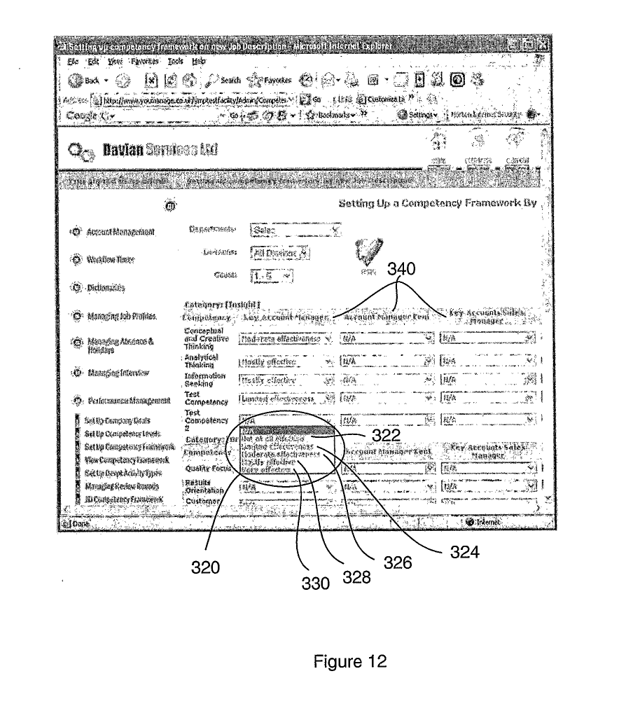

FIG. 10 shows an example of a Competency Framework/Hierarchy 300. Within the framework key qualities/attributes are defined, for example insight 302, drive 304, leadership 306, and working with others 308, each one of which can be broken down to a plurality of associated abilities, for example under the insight quality/attribute the associated abilities include conceptual creative thinking 310 and analytical thinking 312. Therefore, an organisation will define the qualities/attributes and abilities which they require their employees to possess and the degree to which they possess the ability, i.e. how competent does a person doing a job need be. Competencies may be defined using a competency scale 320 (see FIG. 12) from for example i) not at all effective 322, ii) limited effectiveness 324, iii) moderate effectiveness 326, iv) mostly effective 328, and v) very effective 330. ‘N/A’ is used where a competency is not applicable, i.e. where an employee does not require that skill/quality.

Another user (e.g. a Recruitment specialist) could be responsible for defining, for each competency, a set of Interview Questions that are designed to test for that competency. FIG. 11 shows the Competency Framework 300 may be set-up to provide interview questions 330. As shown in FIG. 11, the interview questions 330 relate to the ability relating to conceptual and creative thinking 310. The system permits the user to use pre-stored questions or to compose and store their own questions.

Separately, another user could define the competencies that are required for a particular Job Role, as shown in FIG. 12. As shown, each job role 340 can be set-up on the basis not only of the qualities required for the job but also the abilities/competencies required using the competency scale 322 (mentioned above).

Subsequently, when the manager comes to prepare for an interview for that job role 340, he will be presented with an Interview Script, which is automatically populated with the questions 330 to ask to test for the skills/competencies that are required for that role. The manager has instant access to the information that is relevant to the specific situation (i.e. the Interview Questions 330) without needing to read or understand the complete Competency Framework 300. The manager can perform their role effectively without even being aware that the organisation has a Competency Framework 300.

Within the system, a notification module 400 enables organisations to set-up triggers for pre-defined milestones within business processes, which generate e-mail alert notifications to managers, HR professionals or senior executives—either in advance of the milestone being due or after it is overdue. The alert notifications are also visible on the main page of each user, i.e. the first page a user sees when they log onto the system The milestones and tasks which can generate an alert are pre-defined within the system to make it easy for the organisation. The triggers can be solely time-based or conditional on whether managers have completed key tasks within the system. For example, an organisation could configure the process so that an e-mail alert is sent to a manager seven days in advance of the end of an employee's probationary period. If the manager has not taken action to review the employee's probationary status after a further three days, the system could send a further e-mail—this time to the manager and the manager's manager. If no action has been taken after three further days, the HR Director could be alerted.

The timing, frequency, distribution and content of the alerts is controlled by the user via a configuration module 420 of the notification module 400. This enables the user to use the system to reinforce their own HR policies and procedures.

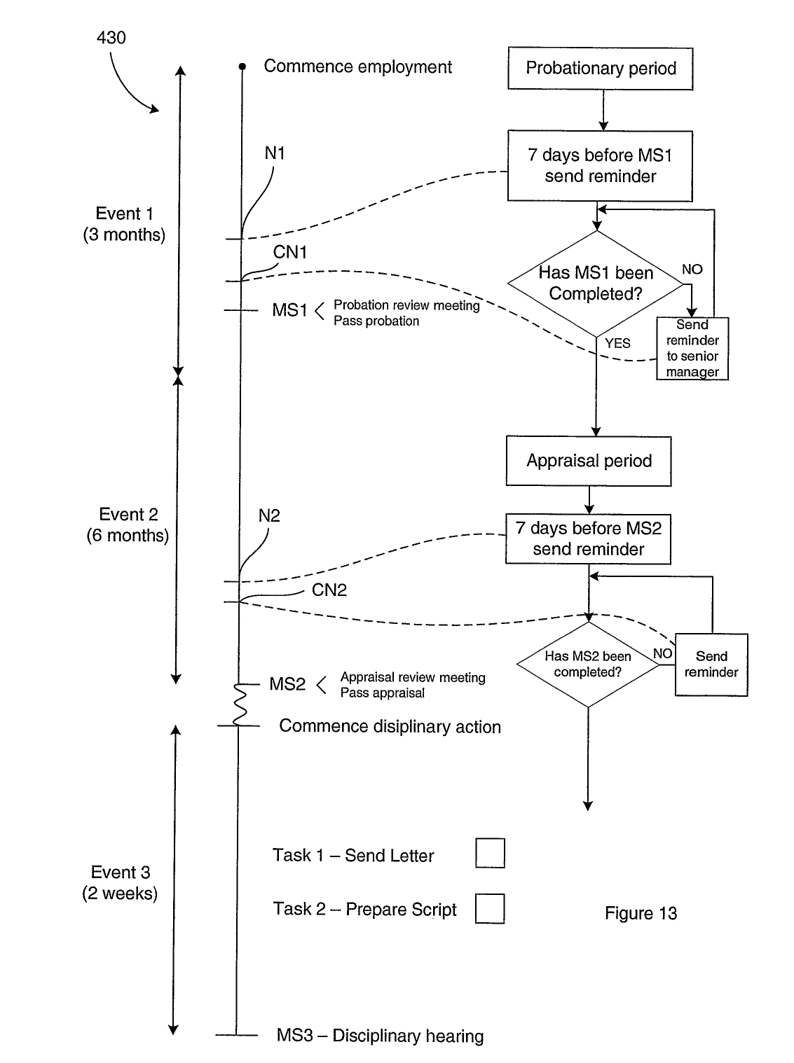

FIG. 13 shows a timeline 430 of several events Event 1, Event 2, Event 3, and milestones MS1, MS2, MS3. As shown, Events 1, 2 and 3 run consecutively. These events may be, for example, a first probationary period, an appraisal period, and a disciplinary hearing respectively. At the end of each event there are corresponding Milestones, MS1, MS2, MS3. In some situations, before an employee can proceed on to a next event, an appropriate user may be required to input into the system confirmation that certain required tasks have been completed. For example, before the end of an employee's probationary period, i.e. at MS1, the employee will meet with at least one of their managers during a probation review meeting, and if the employee passes probation they will continue in their employment and be monitored during an appraisal period. The manager must input into the system that the probation review meeting took place, and that the employee passed. Confirmation of events taking place or tasks being completed may only be input into the system by a user with the relevant permission rights. Within the configuration module 420, an administrator must configure which permission rights a user must possess before a confirmation can be entered into the system.

The feedback, which is entered into the system, enables more accurate reporting regarding the current status of employees and processes within the organisation.

An administrator or other suitable user can set up fixed notifications, N1, N2, to remind the relevant manager when the Milestone MS1, MS2, MS3 is due to occur, for example, seven days before the end of probationary periods or meeting dates. Furthermore, conditional notifications CN1, CN2 can be sent after the fixed notifications N1, N2, if no confirmation that the required task has been carried out is inputted into the system.

The alerting functionality advantageously offers the ability of increasing the likelihood that managers will manage processes consistently, accurately and within the required timescales and enabling senior managers and HR to easily identify managers that are not completing key processes, or not performing their responsibilities accurately.

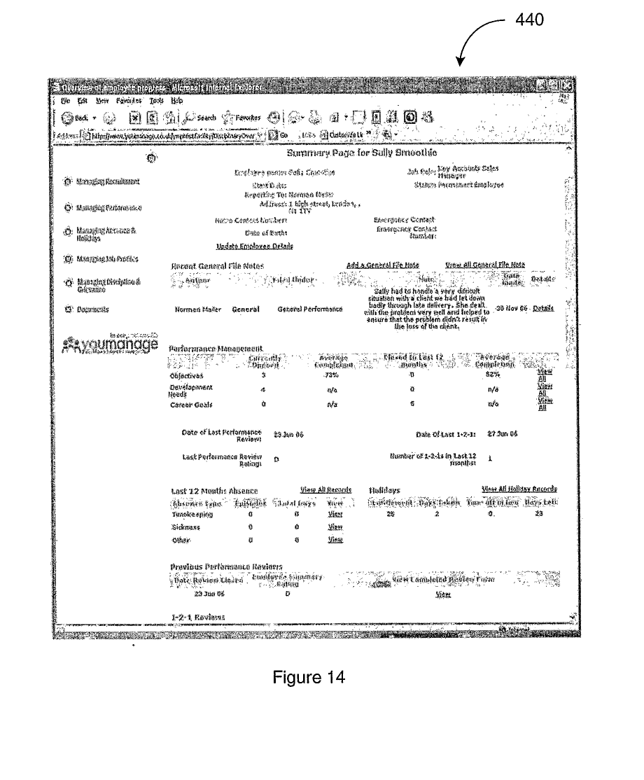

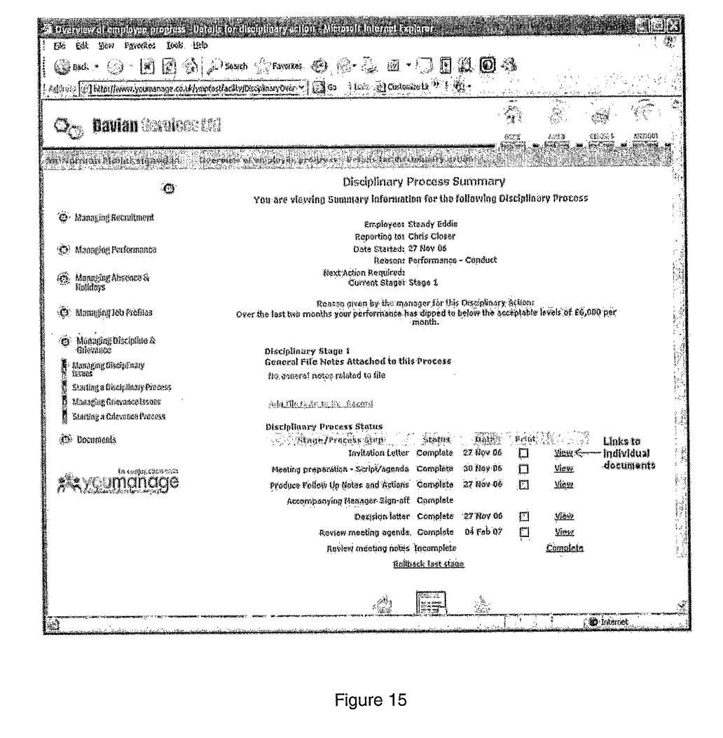

As shown in FIG. 14, an Employee Summary Page 440 can be accessed by a user selecting the employee's name from anywhere within the system. The Summary Page 440 presents a consolidated view of any records relating to that employee. The user can then drill down into any one of the individual process records relating to that employee (e.g. a Disciplinary Process) and view any notes, documentation or outcomes associated with that Process Record, as shown in FIG. 15.

The GUI enables a user to view the exact status of any individual management issue (for example, a disciplinary process, a recruitment round) within their department or Business Unit, along with any information entered by the line manager relating to that process (for example, meeting notes).

The system enables a more consistent and holistic approach to people management by taking stored information relating to an employee's employment history or past performance and presenting it to users at other relevant points in linked people management processes. All of the information input into the system by a user, is stored in a specific location within the database along with contextual information (e.g. when it was created, by whom, at what point in the process) that enables that information to be used subsequently within other processes. Each process step within each module within the system, also contains a set of rules which determine what information is retrieved from the database and presented to the user at that point in the workflow process.

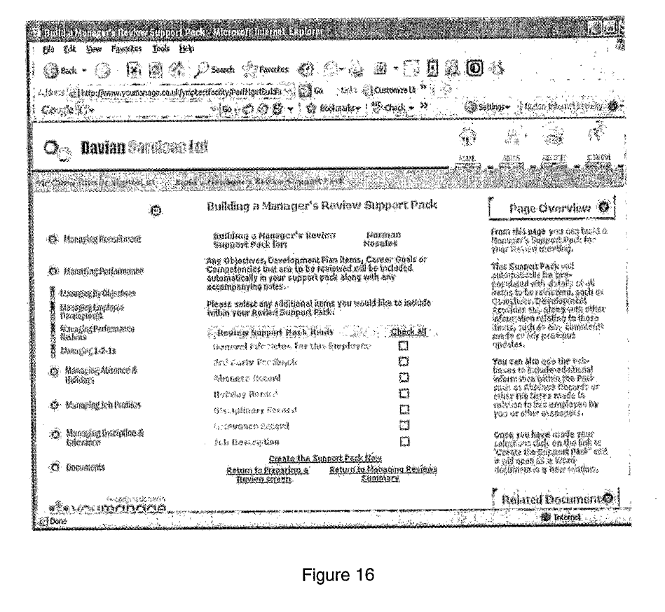

This is illustrated by the following example. Typically, when a manager prepares for a employee's Performance Review he will be looking at a narrow set of data relating to that employee—most likely a set of objectives that were agreed at a previous point in time. However, there is a far broader set of data which would be useful to the manager when assessing the employees performance—for example their absence history, any disciplinary items, the competencies against which they were recruited. In the prior art systems described above, information is not easily accessible and so it will probably not be considered by the manager during the Performance Review. However, the present embodiment advantageously enables the manager to access far more information. With the present system, a manager preparing for a review is automatically provided with a Review Template, as shown in FIG. 16, pre-populated with all items to be reviewed and will also be able to include within this single document other records such as Absence or Disciplinary records. This functionality helps managers to make better, more informed decisions because they have easy access to a much fuller set of data. Furthermore, each manager is directed during each event to act in the manner which is prescribed by the organisation, improving consistency across the organisation.

The system also enables users to record comments and observations relating to an individual employee, and to easily categorise those comments so that they can be delivered to, or accessed by, any other user at an appropriate point within a Management Process.

A General File Notes function is provided within the system which enables any user to record notes in relation to an individual employee and arrange for those notes to be filed under a specific category or categories. These categories can be both system generated (e.g. current objectives or development needs) or defined by an administrator of the organisation. These notes are visible to any other user when they are carrying out an action which relates to that employee, an event, and the relevant category. For example, a manager preparing to review an employee against their current objectives will be presented with any file notes made by any user in relation to those objectives. The file notes can also be pre-populated into relevant documentation generated by the system (e.g. a Disciplinary Meeting Guide or a Review Form) by the document generator.

Unlike the prior art systems described above, which offer no interactive or data capture capability, the General File Notes function does offer this functionality which benefits organisations by enabling a more complete and accurate approach to the management of each individual employee, where the experiences and observations of all managers in an organisation can be factored into the management process. This is particularly relevant to organisations where there is a matrix-based or project-based management structure, where an individual may actually carry out work for several different managers as well as their immediate reporting manager. FIG. 5 is a screenshot of the GUI which shows how a file note may be input to the system.

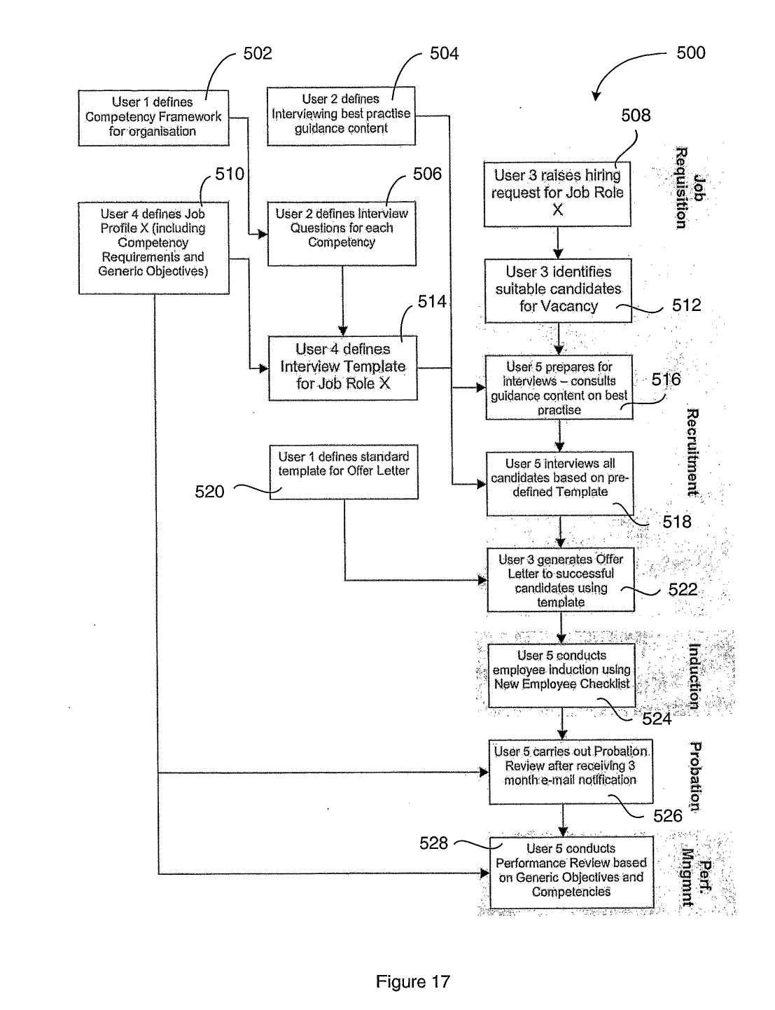

FIG. 17 is a flowchart, offering more detail than that of FIG. 2, relating to part of an exemplary complex workflow 500 concerning HR management comprising job requisition, recruitment, induction, probation and performance management. FIG. 17 is particularly complex because it requires interaction with several different users, and depends on a plurality of different events which happen over a variety of different timescales. Furthermore, some current events require tasks associated with previous events to be completed before the current event can proceed. The workflow is also complicated by the vast array of data which is generated throughout the different steps in the workflow and the requirement that subsets of this data are outputted at certain other steps throughout the workflow.

At Step 502, a first user, User 1, defines the Competency Framework for the organisation as described above. At Step 504, a second user, User 2, defines interviewing best practices and guidance content. Upon completion of Step 502, the second user can define Interview Questions for each competency, at Step 506.

At a time when an organisation requires more employees, a third user, User 3, at Step 508, raises a request for a new employee to fulfil a new job role, Job Role X. A fourth user, User 4 defines, at Step 510, the new job role, Job Role X, including competency requirements and generic objectives, i.e. what skills does the new employee require and what is the job they are being employed to do. The new job role is created on the basis of the Competency Framework created for the organisation at Step 502.

The third user at Step 512 identifies suitable candidates for interview, using the job profile defined at Step 510 where necessary. The fourth user initiates, at Step 514, defining an interview template for the new job role Job Role X and the document generator populates the template using the interview questions determined at Step 506. A fifth user, User 5, prepares at Step 516 for upcoming interviews consulting the guidance notes provided in the additional information area of the GUI, the interview template, and the fifth user interviews, at Step 518, all of the candidates using the predefined template.

At Step 520, which may or may not occur before Steps 506 to 518, the first user defines a standard template for an Offer Letter, which is stored in the system templates. Upon selection, at Step 520, of a suitable candidate the third user generates an offer letter using the template and the document generator and sends the letter to the suitable candidate at Step 522. If the suitable candidate accepts the job offer, the fifth user conducts, at Step 524, an induction process with the new employee using a New Employee Checklist which is a guidance document stored in the system which is pre-defined.

As part of the induction process, when new employees start at the organisation, their details are entered into the system, including relevant dates such as the expected date that their probationary period is to expire.

As described above, an e-mail notification is sent to the fifth user, User 5, ahead of the end of the new employees probationary period and the fifth user carries out, at Step 526, a probation review using the job profile defined at Step 510. Typically, probation reviews include the fifth user meeting with the employee.

At ongoing intervals, for example every six months, the fifth user conducts performance reviews, at Step 528, based on generic objectives and competencies defined in Step 510 as part of the job profile.

Of course, the workflow for an organisation includes more processes than shown in FIG. 17, for example grievance and disciplinary procedures.

In another embodiment, there is provided, within the workflow processes subsystem, a process summary dashboard module which is arranged to control each user's home page such that a summary relating to their team, less senior employees and/or other management related information is displayed in a dashboard region of the GUI screen. Furthermore, the process summary dashboard is customisable such that each user can configure their dashboard region to display data stored within the system on the basis of pre-defined reports, for example, the number of absence days by department.

Having described a particular system, which embodies several of the above described aspects of the present invention, it is to be appreciated that the present embodiment is exemplary only and that variations and modifications such as those which will occur to those possessed of the appropriate knowledge and skills, may be made without departure from the spirit and scope of the invention as set forth in the appended claims. In particular, the field of application of the present invention is not restricted to employment management, but can be used in a variety of fields including any human organisational management, resources management, and complex technical process management. The present invention provides the greatest benefits when used for large-scale management applications having relatively complex workflows. As discussed above, the present management system could be provided as part of a training device for the management of a complex process, for example a management/control simulator.

As discussed above, the present management system could be provided as part of a training device for the management of a complex process, for example a management/control simulator.

Using a simulator as a training device permits management of a complex scenario in simulated conditions which are devised to match real conditions. In this way, certain safety critical skills can be taught without exposure to danger, risk or expense should mistakes be made. Also, the recordal of user actions enables assessment of the user's ability to manage a complex process before the user is allowed to manage the process in the real world.

Within a training environment, there are a large number of elements which need to be controlled. There is a vast amount or information gathered as a result of ongoing processes. This information can be used as feedback to make better ongoing decisions in real-time, for example to correct a process bringing it within defined parameters. Furthermore, where different users are controlling different aspects or portions of a process, such control can be important in maintaining a high degree of consistency throughout the process.

1.-46. (canceled)

47. A management system for assisting a user in the management of an employment workflow process, the system being arranged to generate and record data regarding a sequence of events occurring over time constituting the employment workflow process, the system comprising:
a communications server arranged to output to a remote user terminal, output data relating to a current event of the employment workflow process and to receive inputted user data from the remote user terminal, relating to the current event;
a data store for storing the employment workflow process, output data relating to events of the employment workflow process and the inputted event-related user data in corresponding user data records;
a stored set of event data rules, linked to the workflow process, that govern which output data is to be provided at each particular event of the employment workflow; and
composing means, operable in accordance with the event data rules, for composing a collection of output data, the composing means being arranged to compose the collection from predetermined event data relating to a current event from a database of predetermined event data and historical event-related user data from an appropriate user data record.

48. A system according to claim 47, further comprising a workflow management means arranged to enable user customisation of the employment workflow process.

49. A system according to claim 48, wherein the workflow management means is arranged to use the inputted event-related user data to modify the events and the stored workflow process, such that the employment workflow can be at least partially re-configured.

50. A system according to claim 49, wherein the workflow management means is arranged to modify the events of the stored workflow process within a fixed overall framework.

51. A system according to claim 47, wherein the composing means comprises a script generator arranged to utilise the historical event-related user data and the event-related user data to generate a script of information relating to a current event.

52. A system according to claim 51, wherein the script generator is arranged to generate a script comprising a sequence of instructions.

53. A system according to claim 51, wherein the script generator is arranged to generate a script comprising a series of questions from which inputted user data is to be generated.

54. A system according to claim 48, wherein the composing means comprises a document generator, the document generator being arranged to enable the user to construct text-based documents for use in the implementation of the employment workflow process.

55. A system according to claim 47, further comprising output arranging means configured to arrange the output data to be presented on the remote user terminal.

56. A system according to claim 55, wherein the output arranging means is arranged to determine the format of the output data.

57. A system according to claim 55, wherein the output arranging means comprises a workflow tuner engine arranged to determine the arrangement of supplemental output data to be output to the user with the output data in accordance with the current event in the workflow process and a stored set of supplemental information rules.

58. A system according to claim 57, wherein the workflow tuner is configurable by a first user to determine the types of supplemental output data to be providable to a second user.

59. A system according to claim 55, wherein the output arranging means is configured to output data into a graphical user interface (GUI) for presentation on the remote user terminal.

60. A system according to claim 57, wherein the output arranging means is configured to output data into a graphical user interface (GUI) for presentation on the remote user terminal.

61. A system according to claim 60, wherein the output arranging means is configured to arrange output data into a GUI comprising a menu region for navigating different functionality of the system, a working region for display of the collection of output data relating to a current event of the employment workflow process and a supplemental information region for output of the supplemental output data.

62. A system according to claim 61, further comprising a menu manager for compiling a hierarchical menu for display in the menu region of the GUI, the menu enabling user selection of a specific part of the employment workflow process.

63. A system according to claim 62, wherein the menu manager is arranged to consider the user's data record and generate a customised hierarchical menu for output to the user.

64. A system according to claim 55, further comprising a content management engine arranged to permit user configuration of the output arranging means to integrate appropriate content with events in the employment workflow process.

65. A system according to claim 64, wherein the content management engine is arranged to integrate content that is specified by the event data rules as mandatory information relating to the event.

66. A system according to claim 64, wherein the content management engine is arranged to permit user configuration of a subset of the stored event data rules.

67. A system according to claim 47, further comprising linking means for linking events in the employment workflow process to relevant information, stored in the system.

68. A system according to claim 67, wherein the relevant information is at least one of the set comprising: guidance notes, links to worked examples, and links to related documents.

69. A system according to claim 47, further comprising a search engine, wherein the output arranging means is configured to enable access to the search engine.

70. A system according to claim 47, further comprising a security subsystem arranged to control remote user access to information stored in the system by determining permission rights of a remote user.

71. A system according to claim 70, wherein the security subsystem is arranged to control what predetermined event data information is provided to the composing means, the control being determined by the permission rights of the user.

72. A system according to claim 70, wherein the security subsystem is arranged to control a user's ability to modify stored data of the system.

73. A system according to claim 70, wherein the security subsystem further comprises an audit trail means arranged to record a remote user's interaction with the system.

74. A system according to claim 73, wherein the audit trail means is arranged to note each data element created by the user interaction with the system.

75. A system according to claim 74, wherein the audit trail means records a date of creation and an author, for each data element in the system, and records a date and author of subsequent amendments to data elements within the system.

76. A system according to claim 47, further comprising a reporting means arranged to generate reports of user interaction with the system using at least one report template.

77. A system according to claim 47, wherein the system is arranged to manage a set of workflow processes.

78. A system according to claim 77, wherein the set of workflow processes relate to a set of users.

79. A system according to claim 47, wherein the system is arranged to manage a plurality of workflow processes, each workflow process being independent of another workflow process.

80. A system according to claim 77, wherein the system is arranged to manage a plurality of workflow processes, each workflow process being independent of another workflow process.

81. A system according to claim 80, wherein the system is arranged to manage a plurality of sets of workflow processes, each set relating to a different set of users.

82. A system according to claim 47, further comprising competency framework generation means for generating a competency framework of attributes, wherein attributes are associated with one or more entities and one or more events, and wherein the composing means is arranged to use the competency framework of attributes to select relevant output data relating to the attributes within a current event of the workflow process.

83. A system according to claim 82, wherein the competency generation means is configurable by a first user for application to a second user.

84. A system according to claim 47, wherein output data comprises at least one data element, wherein a data element is one element of the set comprising: a text document, a hyperlink, a video file, an image file, an HTML file, and an Audio file.

85. A system according to claim 47, further comprising an alert generation means arranged to consider the received event-related user data with respect to the set of event data rules and to generate and send an alert notification via the communications server to the at least one remote user terminal if an action associated with an event has not been taken, or if required data relating to an event has not been received at an appropriate stage of the workflow process.

86. A combination of a management system according to claim 47, and at least one remote user terminal operatively connectable to the server via a communications network.

87. A method of assisting a user in the managing of a employment workflow process, the method including generating and recording data regarding a sequence of events occurring over time constituting the employment workflow process, the method comprising:
outputting to a remote user terminal, output data relating to a current event of the employment workflow process
receiving inputted user data from the remote user terminal, relating to the current event;
storing the employment workflow process, output data relating to events of the employment workflow process and the inputted event-related user data in corresponding user data records;
using a set of event data rules, linked to the workflow process, that govern which output data is to be provided at each particular event of the employment workflow; and
composing in accordance with the event data rules, a collection of output data from predetermined event data relating to a current event from a database of predetermined event data and historical event-related user data from an appropriate user data record.

88. A management system arranged to enable managers to record information relating to a plurality of different events occurring during an employment time period, where the system is arranged to utilise stored data to effect best practice in data recordal and advice provision regarding each particular event during that time period including providing user-recorded information relating to a previous event in relation to a current event.

89. A management system as claimed in claim 88, wherein the user-recorded information is provided in accordance with a set of stored rules, which govern how user-recorded data relating to previous events and predetermined data are to be presented to a user during a particular current event.

90. An alert notification system for assisting a user in the management of a employment workflow process, the system comprising:
a data store for storing a employment workflow process comprising a sequence of events occurring over time, and a set of event data rules, linked to the workflow process, that govern how users interact with the workflow process at each particular event;
a data input means to receive event-related user data from a remote user terminal during interaction with the employment workflow process, and
an alert generation means arranged to consider the received event-related user data with respect to the set of event data rules and to generate and send an alert notification to the at least one remote user terminal if an action associated with an event has not been taken, or if required data relating to an event has not been received at an appropriate stage of the workflow process.

91. A system according to claim 90, wherein the alert generation means is arranged to be configurable by a first user for use by a second user.

92. A system according to claim 91, wherein the appropriate stage of the workflow process comprises a predefined time period of the workflow process.

93. A system according to claim 90, wherein the alert is sent via an e-mail to the at least one remote user terminal.

94. A system according to claim 90, wherein a notification of the alert is displayed on a home page of the user's remote user terminal.

95. A management system arranged to enable managers to manage an employment workflow process and to record information relating to a plurality of different events occurring during an employment time period of the workflow process, the system comprising:
a communications server arranged to output to a remote user terminal, output data relating to the current event and to receive inputted user data from the remote user terminal, relating to a current event of the employment workflow process;
composing means for composing a collection of output data relevant to the current event; and
competency framework generation means for generating a competency framework of attributes, wherein attributes are associated with one or more entities and one or more events, wherein the composing means is arranged to use the competency framework of attributes to select relevant output data relating to the attributes within a current event of the employment workflow process.

96. A system according to claim 95, wherein the competency generation means is configurable by a first user for application to a second user.
